(19) United States
(12) Patent Application Publication
(10) Pub. No.: US 2016/0098932 A1
(43) Pub. Date: Apr. 7, 2016

(54) SYSTEM AND METHOD BY MEANS OF MOBILE DEVICES TO STIMULATE BRAIN'S WORK

(71) Applicant: SPW S.C. Hanna i Tomiasz Wachowiak, Bydgoszcz (PL)

(72) Inventor: Tomiasz WACHOWIAK, Bydgoszcz (PL)

(73) Assignee: SPW S.C. HANNA I TOMIASZ WACHOWIAK, Bydgoszcz (PL)

(21) Appl. No.: 14/528,514

(22) Filed: Oct. 30, 2014

(30) Foreign Application Priority Data
Oct. 4, 2014 (EP) 14460064.0

(51) Int. Cl. G09B 5/00; H04L 29/08; G09B 19/00

(52) U.S. Cl. CPC G09B 5/00; G09B 19/00; H04L 67/02

(57) ABSTRACT

The object of solution, accordingly to the invention, is a method and system which use mobile devices for stimulating the brain, characterized with having three logic types of components/sections: information section, wherein the system information part consists of a functional components in the form of administrative panel containing information management, knowledge panel that enables looking through the system's published content and its presentation, newsletter. This newsletter is responsible for handling the subscription process, advertising module, the department of exercise, realizing automatic and interactive exercises, training and lessons divided into 4 subgroups: mnemonic exercises, logical, computational, visual, and independent internal learning module, a database—data collection department and the effects of exercise, containing components: a knowledge base module, the module pseudownioskowania based on user profiles, and manages user accounts and statistics department and assessments.

The subject of solution according to the invention is the way and system by means of mobile devices intended to stimulate brain's work by active supporting of intellectual ability's development, paying attention and memory training, by the system and method by means of mobile devices with access to current and important pieces of information connected to memory training and cognitive abilities' development and exercises' and assignments' automation.

### BACKGROUND OF THE INVENTION

So far, methods of memory training have been conducting in a conventional way or by means of e-leaming platforms from the level of multi-layered web system.

The brain is a peculiar command centre for virtually all functions of our organism. It is responsible for mobility, dream, hunger etc. This pink and grey gunge, which on average weights (in adults) 1,3 kilograms and contains about trillion brain cells in itself (including 100 billion nerve cells and 900 billion nutritional cells, isolating cells etc.), is the biggest miracle of evolution (but appreciation should be also expressed to inter alia an eye). In every second the brain receives incentives from other organs and analyses millions pieces of information (like an enormous telephone exchange) sending between left and right hemisphere. Contrary to appearances, the speed of impulses is not so high—in fact it is from about 0,5-1 m/s on small fibres (axons) to 100-120 m/s on the biggest ones (so it is much less than the speed of sound—about 340 m/s; for comparison: the speed of light—3×10⁸ m/s. The brain is only about 2% of the whole human weight. The most important parts of the brain are its two hemispheres—left and right, which make 90% of its volume. They are covered with meninges which consist of three layers and they are some kind of pillows—they are filled in with cerebrospinal fluid which absorbs shocks. Meninges are after the skull the second protective measure. The surface of brain is wrinkled brain cortex responsible for limbs' movement control and for receiving incentives from sense organs. Beside of hemispheres, basic elements of brain are also brain stem and cerebellum. The brain receives data from sense organs (an eye, en ear etc.) in the form of nerve impulses. The communication between neurons (nerve cells) is both electrical and chemical. Electrochemical impulse always jumps from dendrites (resembling a twiggy limb of tree) through the central part containing nucleus in which data are processed, outside along an axon (in extreme cases proportion of the length of axon to a diameter of a central part can be estimated at 1:1 million) to dendrites of a next cell. Each neuron can produce about 20000 dendrites. Dendrites of one neuron receive pieces of information from axons of the second neuron thanks to the special chemical compounds—neurotransmitters (for example: dopamine or serotonin).

Neurotransmitters are released by synapses, that is shunt between axons and dendrites of single nerve cells (the number of synapses is much higher than the number of neurons—some neurons of brain cortex have several tens of thousands synapses). One neuron can communicate with thousands of others—so even such a simple activity like putting a candle into a mouth engages millions of neurons. The interesting fact is that almost impulses are identical—each part of brain react properly depending on the number of incoming impulses. Thanks to this attribute impulses incoming from hand which touched hot item will get to the brain faster and more frequently than from an ear while listening to relaxing music—on their bases the brain decides which “message” is more important for organism's protection. Scientists who do research on human brain abilities in terms of getting know processes thanks to which the brain downloads, processes and saves pieces of information (so called biopsychologists)—claim that the quality of data transmitting between neurons and their effectiveness can be modified by an experience.

The construction and structure of a brain is more mysterious than the most spectacular objects in space—we still know about it almost as much as about stars and studying its properties is equally difficult and complicated. Fast and effective learning without getting to know at least bases of brain's operation (especially the sphere responsible for data associating and memorising) is impossible. Instead, imagination is a psychical ability to create images (so called concepts) of people, animals, objects, regions, phenomena etc. which exist but are absent in that moment or which do not exist so they are imaginary. The mechanism of imagination is based on (to a large extent) creative transforming its previous experiences. It is activated independently under the influence of different impulses (for example words, sounds, smells, observations) or as a result of conscious choice. In other words, an imagination is an ability to recall or produce in mind any impulses receiving by all senses: images, sounds, scents, tastes, tactile perceptions. An imagination allows for less or more detailed creating in mind any ensuing, hypothetical or unable to occur in reality (so called imaginations) situations. Projections are not so precise as perceptions. What characterise projections are: lesser expressivity, impermanence, fragmentation and very often supremacy of typical, generic or specific qualities over individual qualities. Projections are images of people, animals, objects, phenomena, lands etc. arising in an imaginations.

Other division of imagination classify it by senses which lead us to particular objects:
Visual projections—concern an eye sphere, seeing. There is a common claim that an imagination is only a visualisation. It is mostly because of the term “IMAGInation” where the word “IMAGE” is.
Auditory projections—concern a hearing sphere.
Taste projections—concern a taste sphere.
Olfactory projections—concern an olfaction sphere.
Tactile projections—concern a touch sphere.

Closely related to an imagination is a fantasy of which definition we present below:

Fantasy is a mental ability connected to presenting situations, events which are processing and enrichment of our own experiences. Fantasy is an essential requirement for learning, working, scientific research and for solving different life problems. Fantasy is also an ability to make up, especially by children.

Imagination, and connected to it fantasy, plays a huge role in memorising. So let's look what the memory is.

Memory—it is one of the basic psychical processes thus human gathers pieces of information and gains experience what affects his current behaviour.

The qualities of memory which differentiate people are:

1. persistency which is connected to storage of remembered material and which is measured by time in which particular person is able to keep this material;

2. speed which is measured by time or by number of repeats needed to absorb the material

3. accurateness which is measured by correspondence recalled material to one previously remembered

4. readiness, in other words: easiness of recalling the material expressed by time needed for recalling

5. capacity (range) which indicates on a number and variety of material which can be memorised.

Memory is indirectly connected to the phenomena of forgetting which is a disability of recalling particular material. Memory disorders are most often caused by central nervous system damages, diseases or mental disorders and they can concern memorising, storage as well as recalling. Understanding of above basic terms is necessary for further memory and intelligence development. There will not be any understanding if we demand remembering these terms by heart. We can understand by precise consciously chosen exercises so by practical activities. Superior memory do not have to be characteristic only for very few people. It can be reached by almost anyone who just knows how to activate it. Fast and effective memorising depends more on acquired abilities than on native endowment. Thanks to applying mnemotechnic techniques, proper diet and physical exercises the ability of learning increases even twice. Brain is responsible for all bodily functions. However, each of its hemispheres is responsible for different thing. So: left hemisphere is responsible for speech, logical thinking, counting, mathematical abilities, classifying whereas right hemisphere is responsible for rhythms, music, images, imagination. According to scientists, learning and thinking are in fact creation processes of nerve cells' net and appropriate communication between neurons. When our sense are roused, nerve cells form spikes, so called axons and dendrites, to other neurons. They enable “communication” between nerve cells. Thanks to it, we can recall or memorise pieces of information. With time we develop and learn, nerve cells join with each other in complex formulas of nerve ways. In the fetal period of human life brain hemispheres specialise and superiority of one of them is developed. Hemisphere, called the logical one, generally left one, is responsible for logical and analytical thinking It dresses thought in words, focuses on details, does not create new ideas and only, like a computer, recognises and absorbs data. Thanks to it we easily absorb grammar, orthography and sciences. Right hemisphere is more creative, inventive, synthetic. It acts by images, leads up to generalisations. In the learning process functions of both hemispheres are equally important but at schools students are compelled to use mainly left hemisphere what causes learning much less effective. While writing, reading and counting we have to base on analysis and playback. Imagination is not used in this case almost at all. Most frequently, very good pupils are the ones with superior left hemisphere. Unfortunately, they constitute only 25% of population. The rest students deal with bigger or lesser problems at school and are considered to be inept. As the result, they start to dislike school and do not want to learn. It is proved that human never forgets what he has ever learnt. All thoughts are consolidated in brain in a form of so called engrams—memory traces. Despite of remaining there to the end of our life, we have an increasing problem with their playback. Physical exercises, diet and memory training aim to maintain patency of trails of nerve connections because it is necessary to immediate finding a proper and as big as it is possible dose of information. Herman Ebbinghause, German psychologist who has been doing research on the remembering abilities, has claimed that without memory training we forget approximately 70% acquired knowledge in one hour and 84% in 48 hours.

Memory's aim is to fulfil three functions: remembering, storage, recalling (playback) pieces of information.

Every person has them developed to a different extent but everybody (besides a few exceptions) have the worst developed a retention (storage and playback), This feature has both advantages and disadvantages. Disadvantages are obvious—problems with learning and remembering bigger parts of material, and advantages? Let's consider if we really would like to remember to the end of our life all pieces of information ever heard on the TV or the radio? Retention provides that all data get to the brain, they are selected there and the most important are remembered whilst these less important are gradually erased.

On grounds of remembering time we single out:
indirect, short-term (transient) memory—keeping in mind incentives indirectly after their occurrence
direct, long-term (prolonged) memory—keeping in mind incentives, objects, actions for a very long time, sometimes even for an unlimited period.

Properties of above kinds of memories are presented as follows:

Short-Term Memory
Storage time—from few seconds to few minutes (for example a shopping list)
Capacity—7+/−2 elements; the element can be a letter, a digit, a geometric figure or a word
Fast remembering does not demand an effort, it goes automatically
Material perpetuation—internal repeats; in some cases they ease transfer of material to long-term memory, detection of internal structure or meaning
The sensitivity of forgetting—huge; forgotten pieces of information disappear irrevocably
Format of record (code)—mainly acoustic and visual, sometimes semantic
Access—easy and immediate

Long-Term Memory
Storage time—virtually unlimited (!)
Capacity—huge, unknown, virtually unlimited
Memorization—slower, it demands involvement and paying attention
Material perpetuation—optional learning
The sensitivity of forgetting—small, pieces of information are forgotten seemingly because it is possible to regain them thanks to consciously used special strategies of extraction or they are regained spontaneously, as a result of reminiscence (recalling)
Format of record—mainly semantic
Access—slow, sometimes it demand an effort

Memory division on grounds of types of incentives which have an affect on particular senses:
visual memory (visualizers)—approximately 65% of the whole population absorb faster pieces of information that are written, read or by doing notes
auditory memory (audiles)—approximately 20%—the most effective way for learning for them is to repeat pieces of information at loud or by listening to records
kinaesthetic memory (kinaesthetic learners)—approximately 15%—they remember faster new pieces of information if they are connected to move—for example while walking

Memory, in fact brain, has unlimited capability and on some grounds it resembles a muscle—the more often we work on it, the better effects we achieve. Factors which impair memory. Weak memory is connected to many factors, however in most cases they depend on ourselves. Sometimes weak memory is biological determined or its weakness is connected to different kinds of injuries. However, very often it is a result of our inappropriate behaviour. We often forget about our memory, about the fact that we should take care of it. Probably it is connected to many situations which we deal with every day and we just do not have enough time to care for our memory properly. We weaken our memory by bad diet, drugs, lack of sleep etc. Below we present seven basic factors which impair a memory. Lack of sleep—scientists cannot agree on that point; ones claim that lack of sleep significantly weaken memory working, others claim that it does not have indirect influence on memory; however tiredness caused by lack of sleep has a negative impact on the whole organism—we feel tired, there is no motivation for further learning. Lack of sleep make you stupid. Psychologist James Mass claims that brain needs 1 hour of sleep for 2 hours of work. It is easy to count that 8 hours is an ideal number of sleep needed for an average person. Lack of sleep, Mass claims, causes weak effects at work, tendency to have accidents, is a cause of many illnesses, and even a death. Confirmation of beneficial impact of proper dose of sleep on our intelligence can be a fact that leading physician Albert Einstein was sleeping on average 10 hours per day. Lack of physical exercises—As a proverb says: “a sound mind in a sound body”. Thanks to the physical exercises we can enhance a memory. Frequent move in the open air has a beneficiary influence on the remembering ability and concentration—because move enhances general condition of our health, defeats stress, depressions and improve our mood; Stress—which is almost our inevitable companion, it causes worse mood, we faster feel tired and what is the most important—it causes unwillingness for further learning. Problems with learning are in 80% connected to stress. Let's remove stress and troubles with learning will disappear. Stress at school, at home, at work—it is an inevitable part of our daily life. Obviously, reasonable stress can be motivating for work because it causes secretion of adrenaline which in proper quantities strengthens engrams, however in too big quantities it locks ways leading to pieces of information recorded in memory. Inappropriate diet—“You should nourish yourself, not eat”, this is what one of ads proclaims. Proper nourishing is quite a complicated matter. It is important to eat many vegetables and fruits, sea fishes, nuts which contain big quantities of microelements, to drink much water. It should be obvious that harmful for memory (and not only) are all kinds of drugs, however some people smoke cigarettes or drink many cups of coffee and claim that it helps them in concentration and it is strictly connected to a memory. But generally for the whole memory drugs are not indicated. Our brain needs energy to efficient working so we should eat many vegetables and fruits which are the source of glucose and vitamins. Also never forget about having breakfasts—thanks to this the important meal brain (and whole organism) is provided with energy after a whole night rest. Distraction (lack of concentration)—as we have mentioned above, concentration is strictly connected to memory. Distraction is nothing else but lack of concentration. If we are absorbed by different matters, our thought are in different place—probably nothing will help us with remembering. If we start learning and think about events that have happened this day at school or at work—for sure we will learn much longer and we will forget these things much faster than if we devote the maximum of our attention to what we are doing right now. Lack of revisions—according to the theory of British psychologist Alan Baddeley, possibility of forgetting pieces of information or events depend on how often we recall them in our memory. The possibility of forgetting pieces of information which is only once recalled is huge. Non-systematicity—only revision is not enough—to reach successful results, we have to revise systematically. Revisions and regularity are connected to the phenomena of solid remembering, even to the end of life. Scientists agree on one thing. You should systematically repeat an appropriate material and increase the time between next revisions. If it comes to the number of revisions and time between them we encounter different opinions in literature. The most frequent scheme is as follows: the first day—three times with several hours' break, the second day—two times with at least eight hours' break, after several days—one time, after a week—one time, after a month—one time, after 6 months—one time, after an year—one time.

Avoidance of mentioned above errors and behaviours should state the minimum in memorial prevention. But obeying bottom rules should make learning less stressful and remembering more permanent. Below, we present several factors that enhance a memory.

Motivation—pieces of information are the best memorised when we have enthusiasm to do this. Try to be interested in subject you actually learn. Scientists have proved that better remember things which are associated with positive emotions. However, if we still do not show big interest (for example somebody can be genetically determined to have scientific brain and has to remember many things from History), we should try to strengthen it even by using from attractive sources like ornate books, multimedia computer programs, the Internet etc.

Multi-sensuality—we remember in the fastest way when we engage all possible senses. The more pieces of information we join, the more pieces of information we remember. During learning we should engage as many senses as it is possible—use images (draw, make notes), sounds (speak at loud, listen to recordings) and move (walk through the room, tap the rhythm). Using different senses at the same time we force our brain to increased concentration what causes better transfer of pieces of information from short-term memory to long-term memory, so it facilitates remembering. Also try to recognise which sense during learning is more adequate for us, and what is more important, which sense provides the best effects (in other words, if we are visualizers, audiles or kinaesthetic learners) and use it in the first place.

Mistakes—do not be afraid of mistakes and failures—if we cannot commit something to memory for a long time or we made a mistake—remember that mistakes are an inseparable part of learning—we learn from our mistakes—so let them be a mobilisation for further increased work than a cause of stress. Do not let yourself be bored or tired because of the weak belief in your own abilities. Repeating words like “I will never remember that”, “I am too stupid to learn it” for sure will not help. Just the opposite—it will cause that learning this material will be in fact more difficult.

Aim—let's state an aim but do not try to reach it at all costs straightaway because it can end up an immediate failure. Divide it into smaller stages (sub-aims) and gradually execute them. That has also to do with a number of beginnings and endings, so also a number of strands. The more strands appear during remembering, the better it is for us.

Time of the day—it plays a huge role while remembering, although it is very individual matter connected to “body clock” each of us. However, generally it is the best idea to learn enormous batches of material in the evenings and repeat it in the morning immediately after wakening up (during a sleep the most important pieces of information are solidified and less important are gradually erased).

Quantity of material and order of learning—it is worth dividing a batch of material into smaller parts and learn them in a different order. Fix a plan of revisions of particular material batch (for example: in an hour, in a day, in a week, in a month etc.) and remember that in order to transfer something to the long-term memory, the number of revisions should be bigger than the number necessary to learn.

Exaggeration—this matter is connected to a fairy-tale-like logic, to unreality, weirdness, magnifying and microcopying, humour. Notice that for example we remember much faster magnified images than these in natural size, exactly like something we do not often deal with, something which outstands against the background of sad, ordinary daily routine.

Continuity/Systematicity—do not stop learning—it can sound scary to some people but if we do not want to have problems with remembering in a few years, we ought to practise our brain all the time because every remembering causes creation of new synapses and connections between them. Their number, in turn, is responsible for the condition of our memory. The more pieces of information we join, the more we remember.

Music—it decreases stress, eases fear, add an energy and enhance memory. Music makes people more intelligent. Bulgarian psychiatrist and pedagogue, Georgi Lozaow, has proved that music has a beneficiary impact on remembering. But it cannot be arbitrary music. It has to be kind of music that let us go for quiet—the best are baroque pieces of music and compositions of such artists as Vivaldi, Bach or Handel.

Mobile devices (portable) are electronic devices which enable processing, receiving and sending data without a need to maintain wired connection with a net. A mobile device can be carried by an user without a need to engage additional means (definition proposed by M. Macutkiewicz in the thesis “Using of mobile solutions in systems of e-commerce class”). Examples of mobile devices which find appliance in the system and method of patent solution which is being discussed. A palmtop—a pocket computer, a cellphone, a smartphone, a tablet (a computer), a notebook—a personal portable computer, pocket PC—a pocket computer, Smartwatch—connection between an user and his smartphone or tablet, Watch Phone—independent device—a watch with a phone, a pendrive and multi-functional multimedia device.

Smartwatch, by connection and communicating a few devices, causes that the power of its influence is bigger than each of these devices separately. By communication of a device in type of Smartwatch we can join and control from the tablet or cellphone. Smartwatch is a middleman between an user and its mobile device. We can recall it from the movie from 80′—the main character were moving away a cuff of an elegant shirt in order to enter a sequence of signs on a face of wrist watch. And behind his back we could notice an effect, most frequently in form of huge explosion. Although, developers of the biggest electronic concerns have decided that their propositions will have a bit different application. Primarily, they focus on communication facilitating on the line smartphone—an user. Increasing sizes of cellphones with a touch screen have both many advantages and many disadvantages. One of the advantage is that screen are more and more readable which are totally simply and intuitive in handling. Currently, smartphones successfully replace laptops and they deserve the name of a personal computer of 21th century also on ground of the fact that we have them all the time with us. However, big screens cause that not every smartphone is convenient and ergonomic, especially in case of people who have smaller hands. Admittedly, producers try to deal with it in many ways, for example by offering a software thanks to which we can freely operate even by one hand on a more than 5-cales phone. However, a number of flooding notifications and pieces of information which cascade to us every day causes that continuous pulling smartphones out can turn out to be impractical. In theory, smartwatch is a short-cut which link an user to a smartphone's screen when it safely rests in a pocket, bag or just lies somewhere near to us—but not within reach—but in reach of Bluetooth signal. In practise, thanks to the Bluetooth connection, we receive the ability of controlling cellphones functions from a wrist. Due to the fact that cellphones still are about voice communication, thanks to a smartwatch we can receive, reject or hush the signal of incoming connection. These types of devices are always equipped with a handset so we receive an ability to talk on the phone without pulling the main device out of a pocket. On the smartwatch's screen we can see who calls us so the voice in a phone will not a surprise to us. Despite of big interest in social media services, traditional SMSes are still very popular. The smartwatches' screen are readable legible enough to read the message that we had got. If we add an appropriate application to it, we will be able to choose several patterns of responses in order to send a response from a watch. Nevertheless, social integration could not be missed—smartwatches will allow to receive notifications from the biggest communication platforms like Facebook or Twitter. From a wrist we have also access to a weather forecast, calendar, e-mail box or MP3 player. This kinds of devices are very functional. Modern devices as smartwatch can cooperate with each smartphone which mechanism is administered by an operating system. In case of smartwatch, there is a need to be a Bluetooth which connects to a main device—data base. The newest smartwatches enable making a call or receiving SMSes. They are equipped with screen resistant to cracking, most often covered with sapphire glass. They are equipped with camera which can take photos very quickly and even record films. In a case of communication with smartphone or tablet, multimedia do not have to burden a smartwatch's memory. It is enough to send them to smartphone's memory—this is one of the reasons why Bluetooth communication exists. Despite of the fact that the first visible function of smartwatch is informing about time and date, it has got all applications known from smartphones, but considering a size it has minimalistic graphic motives, what however does not interfere with convenient using. In their menu we can find many short-cuts to many unnecessary applications (calendar, gallery, camera, weather forecast). Moving towards menu is unbelievable simply. It is sufficient to move a finger across the screen or up and down to close applications. So the device which we can carry on a wrist is a short-cut and connection between an user and his smartphone. In contrast, Watch Phone is an outright device which functions independently. The device which contains benefits of other devices deserves special attention. Contemporary devices like Watch Phone cooperate with each GSM net. They are equipped with sensitive, touch screen. They support memory cards—for the sake of a size in Micro SD format—what does not cause a huge obstacle. Currently, on a market we find these cards in a capacity of 64 GB what constitutes quite a big bank of memory. These devices still have Bluetooth built-in—consequently they have a possibility of plugging for example a handset, music player and communication to other devices. They support images, videos, GPRS, SM, MMS. They have in-built cameras, PenDrive function and search engine. Due to a size they are equipped with additional exterior receivers and microphones. The device like Watch Phone gives us comparable possibilities to smartwatch, however they are independent devices. If we are in a continuous move, and in a crowd of work we often forget about many things—Watch Phone will become an essential element of our life. Fusion of standard watch and multi-functional device is a solution, taking into account an easy access to all kinds of applications and additions, which is conventionally distributed into several devices. Watch Phone, similarly to smartphone, is supported by touch screen and functional buttons. The device responds also to a finger touch (it has calibration system). The structure of menu is very simply and legible—similar to the one in cellphones. Even a person who has not got fair knowledge of technology can use it without any problems. In spite of the fact that Watch Phone is one of many mobile devices, it seems to be the more universal and it contains features of other mobile devices. Therefore, the patent description will be mainly based on the system and method of using this kind of device to stimulate brain work.

### SUMMARY OF THE INVENTION

The system and method of using mobile devices in order to stimulate brain work according to the invention is a system dedicated to people who want have efficient memory and develop it. Moreover, they are also so busy that they are not able to devote time on participation in special classes, trainings, meetings of which offers there are many on a market.

The system and method allow to reach an aim without mentioned activities which engage time. Pieces of information from an user are gathered au courant—in both conscious and automatic way, and then individual exercises are adjusted which provide the highest effectiveness of memory improvement and development.

The essence of subject invention is active promotion of intellectual abilities development, concentration and memory training by making available and enabling application of system using mobile devices which guarantee inter alia: Access to different kinds of current and important pieces of information connected to memory training and cognitive abilities development and automation of assignments and exercises which so far have been conducted in a conventional way, even by means of e-learning platforms from the level of multi-layers web system.

### BRIEF DESCRIPTION OF THE DRAWINGS

The system according to the invention is presented closer on attached schemes on which:

FIG. 1 system with division into 4 kinds of logical constituent chapters,

FIG. 2 Informational division of system with functional components,

FIG. 3 system of division and realisation of exercises branch,

FIG. 4 presents layout of relations in type of an user and a mobile device

FIG. 5 contact in type of an user—Smartwatch

FIG. 6-7 system and layout of system mechanism

FIG. 8 Mechanism of informational part of the System

FIG. 9 layout of exercises divisions—component of presentation and management

FIG. 10 the scheme of system mechanism

FIG. 11 the scheme of component of sonde

FIG. 12-13 the scheme of the method of system mechanism

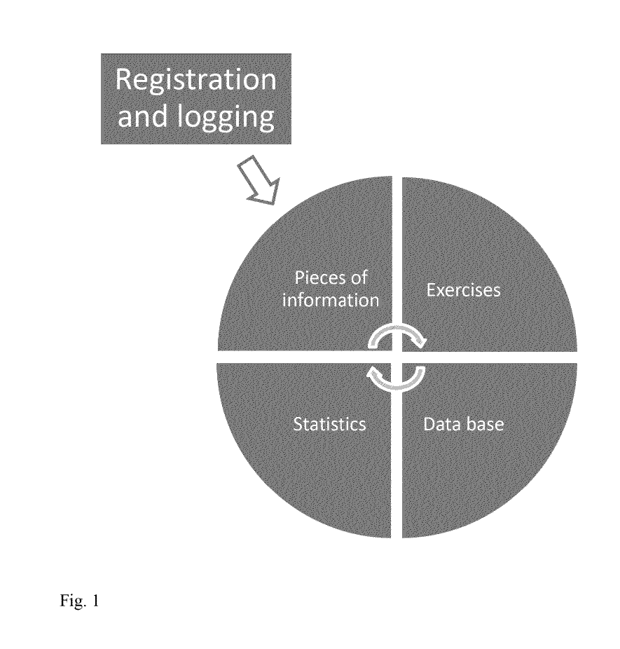

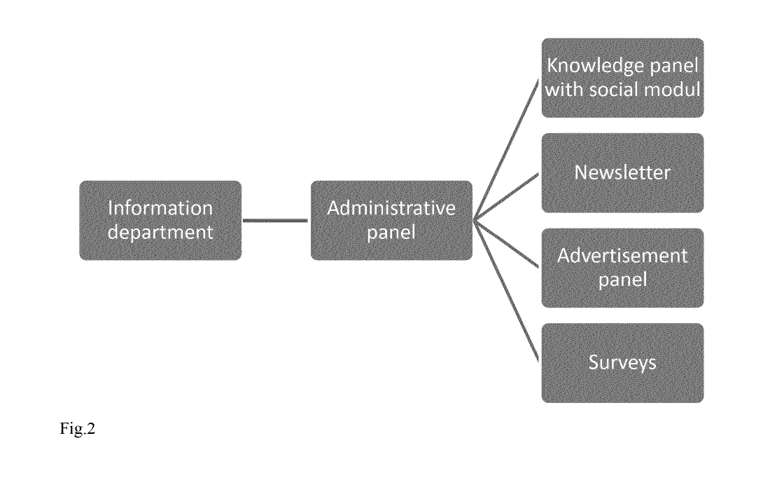

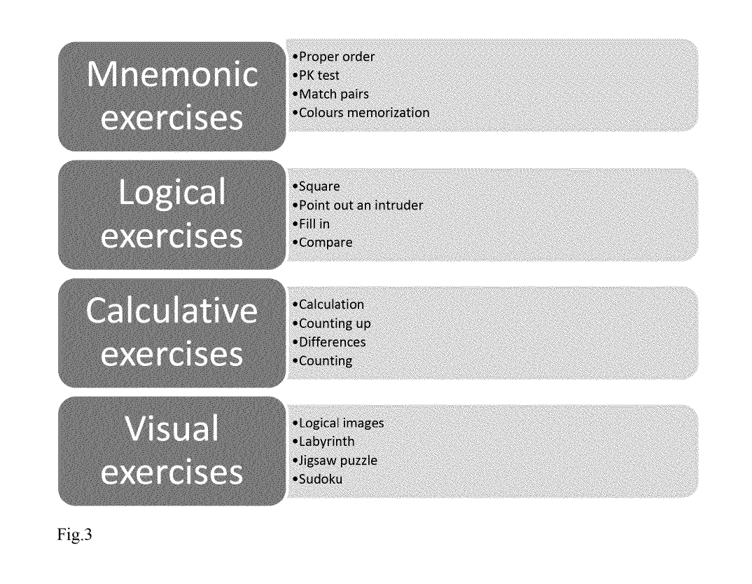

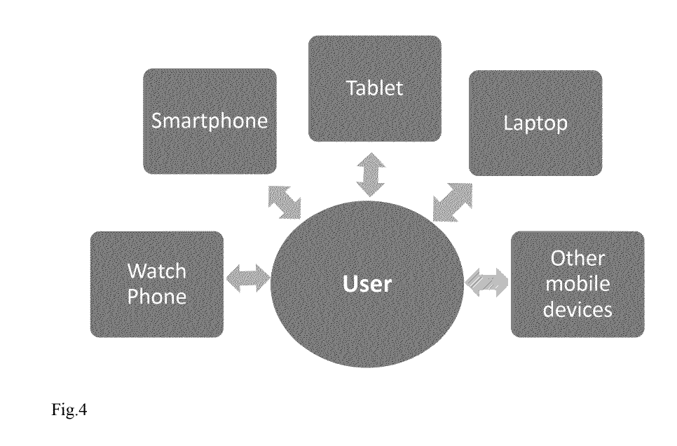

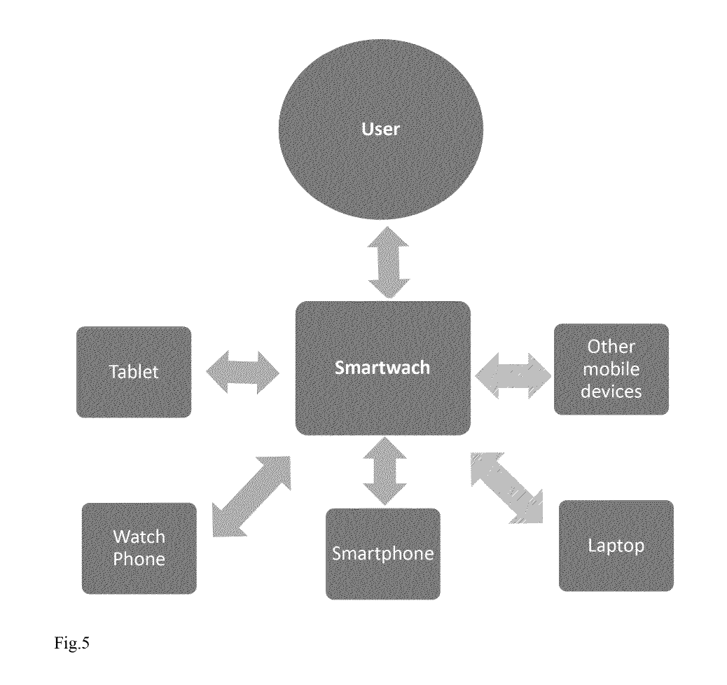

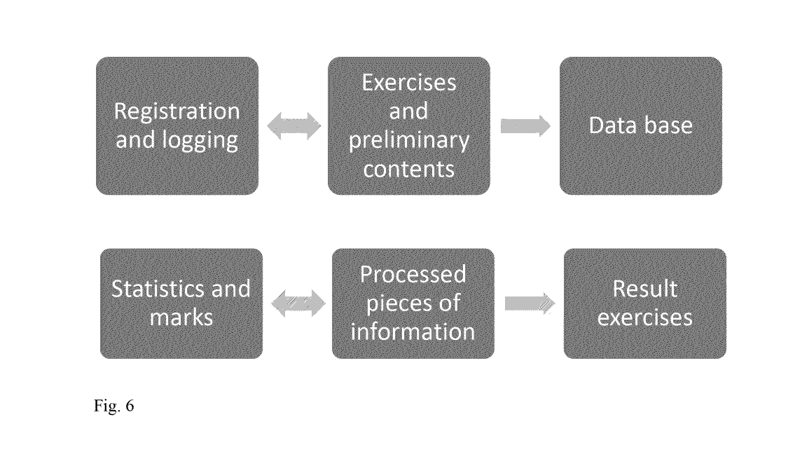

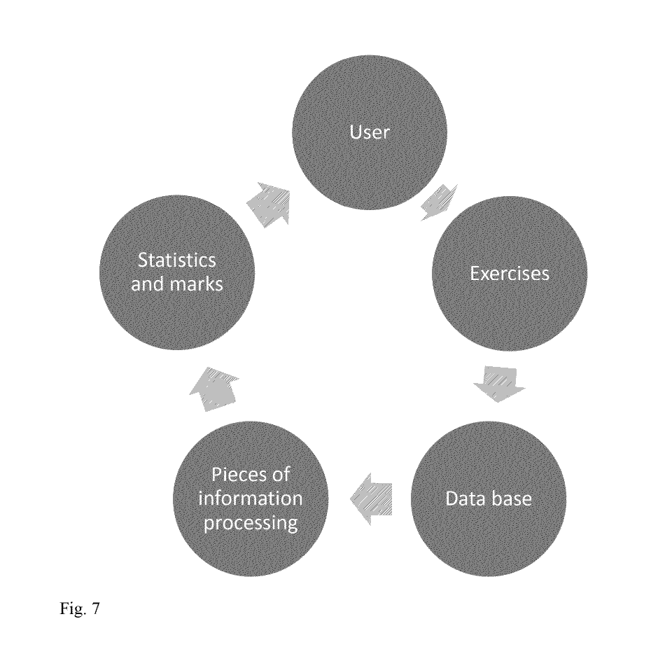

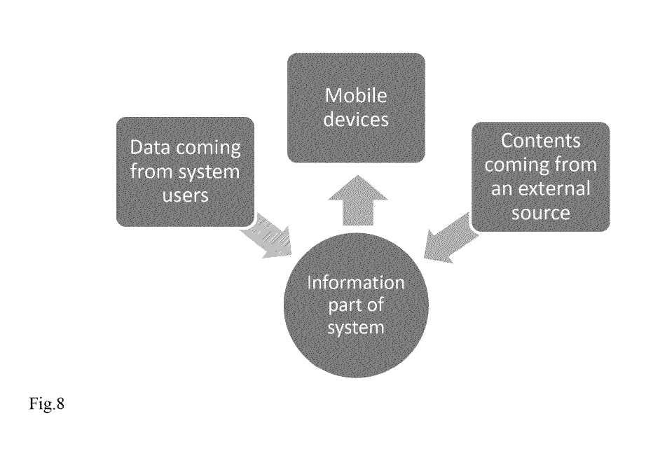

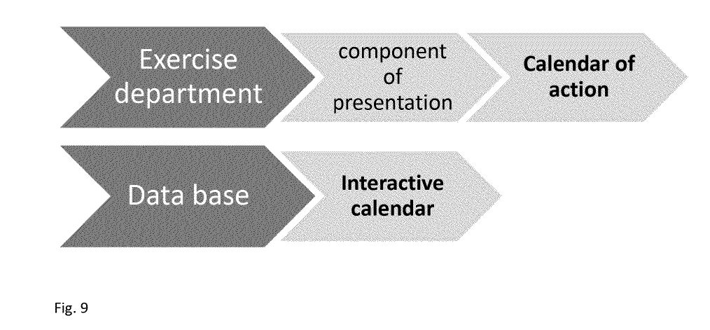

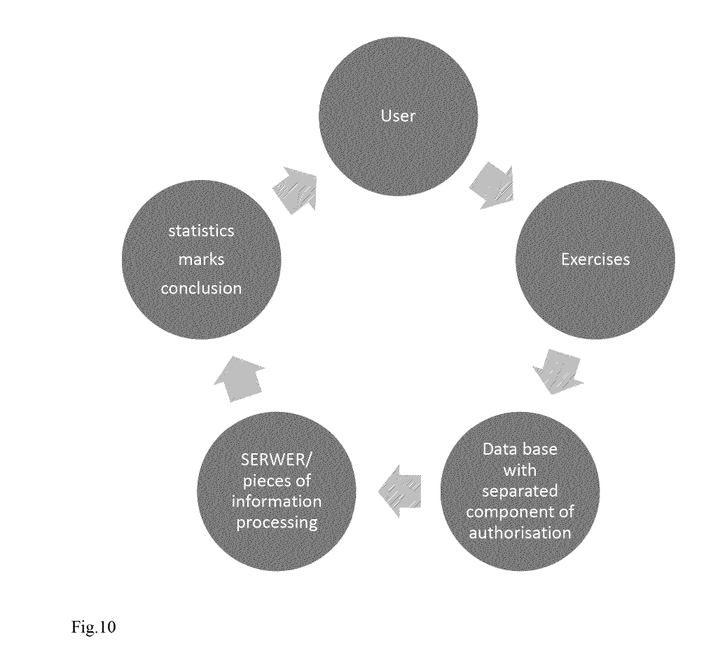

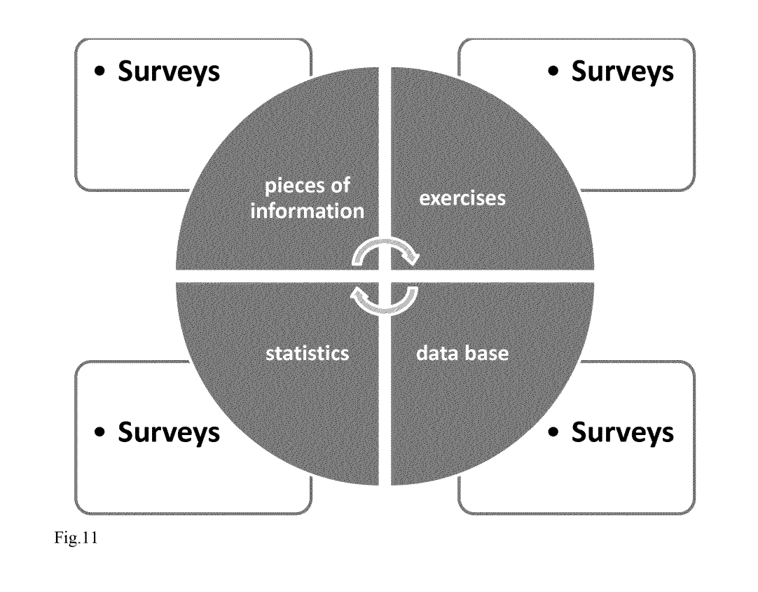

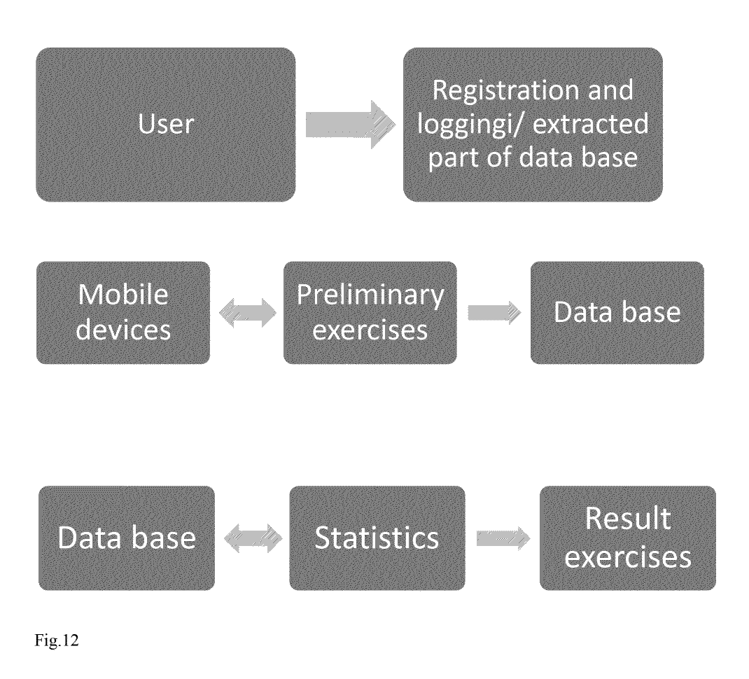

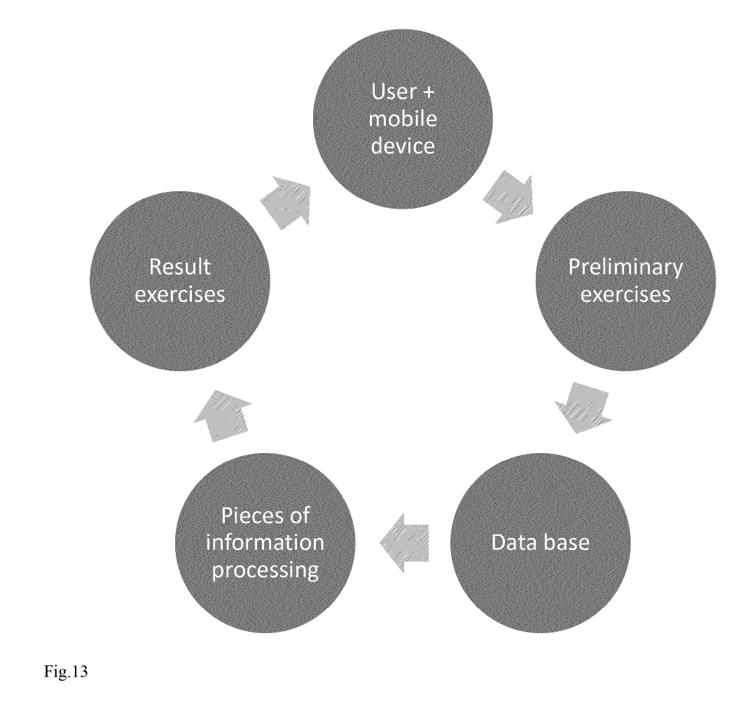

### DETAILED DESCRIPTION OF THE INVENTION

The technical-design description presents technical architecture of the system and functional architecture of the system with a division into components and dependences between them.

| Definition | Description |
|---|---|
| System | The system and configuration which is using mobile devices so as to |
| | stimulate brain work in presented paper |
| Administrator | Editor additionally authorized to set up bank accounts on behalf of others |
| Redactor | A person who has access to administrate the system; he/she manages |
| | contents as well as other dynamic elements published in the system. He/she |
| | is allowed to change the system's default settings, to run upgrate of data and |
| | resources which are used by the system |
| Visitor | Anonymous, not registered user with access to a selected part of |
| | information system |
| User | A person who uses the system's resources |
| Client | A person who sets up an account and gets access to the system, which |
| | enables him/her to use particular e-services available as a part of The |
| | system Every client has a precise, profiled access to the system's training |
| | resources. The range of access depends on achieving results and date |
| | collected by the system, full acess to Informational Department of The |
| | System and very limited access to a part of the system allocated to compose |
| | tasks independentindependently |
| Department | The system was divided into departments being its main thematic modules. |
| | And the division is as follows: the deprtment of ollecting information as |
| | well as recording effectivness of exercises, the depratment of mnemonic |
| | exercises, the deprtment of logistic exercises, the department of |
| | computational exercises as well as the department of visual exercises and |
| | the department of statistics and results and also an informational part of the |
| | system. |
| Category | A part of The Department which is a consistent and integral part of a |
| | project |
| Activity | An element separated from the department contining a detailed single |
| | exercise. |

A functional architecture of the system:

The system and method of the invention which uses mobile devices to stimulate the brain is a unique system that combines the latest technology in the field of distributed e-learning systems. Those systems use solutions from the fields of artificial intelligence, data processing as well as recognition of the data which are based on certain classifiers and estimators, with modern memory training methodology. This methodology has been developed throughout the years by prominent experts in the field of knowledge.

The system carries out tasks connected with:
looking thorough the content, publication of a content as well as grouping it in the hierarchical structure of thematic directory or their management (adding, deleting, editing)
users management and their privileges in terms of access to the features and functionality of all the functional modules of the system
automating exercises by using a modern system of exercises
cataloging and selling products and services with a fully automated service of payments and e-invoicing transactions
servicing probe's boxes, newsletter and other informational boxes which are presented under the system
looking through and searching data sets and contents published in the system

In the described system 4 types of logical components/departments can be distinguished:
information department
exercises department
data base—the department of gathering not only data, but also the effects of exercises
statistics and evaluation department

The system and the method of working

The first step towards using the system is to registration and login, which are one-off actions. Then, consecutively enter basic data: age, education, gender, interests and cognitive preferences. On the basis of this information, the system prepares a set of initial exercises Results as well as a user's profile go to a database where they are manipulated, and then included in statistics. On the basis of that, however, the system generates another set of exercises more adjusted to preferences and skills, or form of a user. The cycle begins to repeat. Note, however, that a user can, throughout the whole time of using a device, enter and change initial information, thus change the set of assigned exercises. A user, however, neither has the power to change the results of exercises, nor to correct them. Results and evaluation largely determine the subsequent portions and sets of tasks and schedule their distribution.

Information Department of the system primarily consists of news presentations, newsletter, advertising module, and elements of social networking aimed to users of the system.

The informatory department consists of functional components connected with each other. And that includes:
Administrative panel—accessible only to users as high in a hierarchy as vice-chancellor and administrator of the system who are responsible for managing the systems' information content and its respective components, in particular the presentation layer, information concluded in particular parts of the system, individual boxes in the system (newslettter, probe, selected news or advertising boxes.)
Knowledge panel—this part of the system enables to browse content which is published in the system as well as presentation of this content in a form of classified lists divided accordingly to thematic categories.
Newsletter—a component responsible for handling the process of newsletter's subscriptions under this system. This component Enables to operate in proper sides of information part of box newsletter system. What's more, this component empowers a user to subscribe messages of a newsletter type from the system. The component, when it comes to its working, is connected with an administrative panel. By means of this panel a user, who has a rectors' permissions (Administrator), can manage a content which is displayed in a box demonstrated in the System. Moreover, such a user can also manage messages addressed to users and a content sent to newsletter's subscribers.
Advertising module—presenting and encouraging you to make use of an expanded range of service offered by service provider

All users have access to the information part of the system without authorization. Contents published in an information part of the system are rooted in two different sources.
The first source is the administrative panel. The editor uses this panel in a process of managing the content—he introduces or modifies contents. Furthermore, he also assigns it to categories and defines the date of publication.
The second source, however, is an outside source form which the component, through a proper interface, downloads articles coming from outside sources. Messages are available in the form of XML at the specified URL. Contents go to the base data system to News category and are published immediately after importing them to the system.

The system provides an opportunity to place text and multimedia content from through a web browser, without knowledge of specialized languages or software. In general, from the administrative panel an editor and a system administrator is able to manage the substantive content, meaning the content and the presentation part of a particular component of the System.

Department of exercises primarily deals with automatic, interactive exercises, training and lessons. This department was divided into 4 subcategories connected with development of specific cognitive abilities: mnemonic exercises department, department of logic exercises, computational exercises department, department of visual exercises,

Due to methodical issues, exercises are carried out from 4 subdivisions steadily adjusting their tempo, scope and detailed requirements to a user. Furthermore, department of exercises is equipped with special learning module based on previously performed exercises, conducted lessons or answers to questions.

Exemplary descriptions of exercises: Each type of an exercise is associated with a wide range of a complexity degree and a wide range of an exercise's difficulty degree. The quality of an exercise is influenced by several elements:
time of performing a task
the amount of elements used in the process of memorizing
elements which impedes memorizing (additional sounds or visual elements)
the length of an exercise
time of a day
time of response—exercises are presented in specified dates, previously defined by a user. However, user's rhythm of the day is also taken into account and then, on the basis of concluding module, is adjusted to the user's profile.

Mnemonic exercises:
A proper order—it's crucial to indicate an order in which images appear (
stm test (short-term memory)—it's needed to repeat and recreate from memory constantly increasing string of letters (small and/or large), numbers (Arabic and/or Rome)
fint the match—a typical game of a memory type
Remembering colors—exercise analogous to the sequence of images—in an advanced version, memorizing of the order images can be combined with memorizing of the order of colors at the same time visual exercise—associated with the reflexes and a visual—motor coordination
Square—Identifying the amount and distribution of the highlighted parts of the square
Point an intruder—an indication, on the basis of the sequence, a non-matching elements
Complete—an exercise on identifying the next element of the previously presented sequence
Compare—find the difference on the basis of two presented “action”—images or video sequences, which ability to watch is allocated a specific time computational exercises
calculation—various types and varying levels of difficulty of math exercises
calculation—a quick elements counting that appear on the screen
time difference—an indication of the time difference on the two walking clocks
counting and memory cataloging of different types of sounds emitted logic exercises
logic pictures—completing an image's “pixel” on the basis of the presented message
labyrinth—various types of labyrinths (flat, space, 3d). During going through the labyrinth participant solves various logical tasks
puzzle—putting together a mixed picture of the cut elements—initially stagnant, then moving
Sudoku—a typical puzzle game consisting of various types of square and various range of numbers

Department of exercises is equipped with a component of the presentation and management of widely understood calendar of actions and events, based on which a personalization of shares is being made under the User account. In this case, a calendar of actions presents the user-defined classes on the basis of the preferences and previous results.

The calendar of system's actions is based on the module categorized under the personal profiles of events entered by users. A component provides a following functionality:

1} Entrance music (calm music is playing as people are entering) Presentation of a content of a single event/action

2. Through filtration or presentation, looking, in the system, for events or actions which meet the filter criteria

3. A presentation of the list of elements entered by users

4. Analyzer and a concluding module on the basis of a Calendar's data base

Department of gathering information as well as the effects of exercise-meaning a database—makes authentication and authorization of users. This department consists of the knowledge base, as well as pseudo concluding module based on the profiles of users. The management of users' account has a transparent administration panel which, on the other hand, contains probe module and psycho tests. But above all, it contains an interactive calendar on which basis different profiled actions are put in motion.

The calendar of actions, with which we deal with in the exercise section, should be, however, separated from the interactive calendar presented above. First of them is responsible for presenting to particular user an accurate, fully personalized and adjusted to him exercise contents and knowledge.

An interactive calendar is located in a section of the database. It positions user's results, processes and sets them as well as forecasts and programs the next set of exercises, which in turn, is presented by the presentation component which closely associated with the calendar of actions located in the section exercises.

With regard to estimated development of the system as well as to serving a vast amount of users add date, the date base is located on an outside server with which the device communicates. Therefore, for more precise description of the invention a scheme how it works should be supplemented with an outside server, as in the following diagram:

Authentication, authorization, and managing users' accounts—an important, albeit functionally separated segment of the database—a component whose task is proper identification of a user and, in accordance with the role that a user has in the system, assigning him/her appropriate permissions. Additionally, a component is responsible for managing number of operations related to managing users' accounts. Such operations include: editing a user's profile or reminding a forgotten password.

Statistic and rating department contains a transparent module. This module incorporates statistic of results and progresses made by users Apart from that, it also contains a log built on the basis of daily assessments and progress made by a user. At the same time the module shows his/her achievements in comparison with a properly profiled audience. Exercising scenarios are created automatically, and are adjusted to the needs of each of the users on the basis of advanced concluding algorithms of the system.

Each of four sections has a probe component which is responsible for a presentation of a box. The presentation is prepared on the basis of pre-defined data defined by the functionality which available under the administrative panel. This component allows to operate on respective sides of information part of the box probe system. Thanks to this component, a user may take part in voting, see the results of voting, look through archival probes and have a vote on them. The component of a probe is, in relation to its working, connected with a component of an administrative panel. User with permissions of an editor (System Administrator) can manage the content presented in the probe's box, arrange the manner of voting as well as an output results.

The main goal of the system is a daily, intensive work on our brain and our development as well as on moulding our cognitive ability. Each exercise should be done in an allotted time. The result depends on amount and quality of performed tasks. And the result, however, translates into an assigned set and sequence of tasks to perform. Bear in mind that it's strictly adjusted to a particular user. At the end of each of an everyday set of tasks, the total score of a whole day is calculated, saved in a data base, and then statistic present those results which are the basis of consecutive tasks.

The method of operation of the system accordingly to the invention is as follows: firstly a user signs into the system through a created for this purpose database's component authentication, authorization, supporting users' accounts. Then, he/she gives some initial identification information and does a short quiz. On the basis of already completed tasks, we make an appropriate functional scope available for a user. A component aimed to a calendar management uses functionality of an already described component, but the full functionality of a calendar component is only available to properly authorized users. What is more, administrative panel of the system also uses functionality of an already described component. The administrative panel of the system is only available to editors and administrators of the entire system. Furthermore, from administrative panel (which is a demarcated part of information section) there's possibility to define users who has editor's permissions. I can be done only by the user who is an administrator of the system. Information part of the system presents contents entered to the database of the system through administrative panel, or through an authorized interface which is made available through an outside component (this component provides articles in a form of XML files for a chosen thematic services). from outside sources. An information part presents various informational boxes, two of which, because of different character of shared functionality, are separate components.

1. User using a mobile device with access to the Internet, registers in the system by entering his/her basic information: name, surname, age, sex, education, way of spending leisure time, occupational status, interests

2. Immediately after registering, the system verifies transmitted data, and creates a user's account, sending him/her the password to access the system.

3. On the basis of his/her profile data, the system assigns profiled tasks, first texts and quizzes. The system also schedules the deadline.

4. The mobile device, correlated with the system, functions as a reminder of specific activities and tasks that were imposed on the user who decided to undergo the process of training memory.

5. The user solves tasks, and information of his/her results are transmitted to a database that is located on an outside server.

6. One the basis of results, in the data base information is processed, the system of statistics is built and the next task is assigned—this task is a consequently connected with previously performed tasks.

A detailed description of how the system works is presented below in an example of performing

1. User Jan Kowalski registers in the system—he enters his basis data. For this purpose, he can use any mobile device or a PC. This action is one-off.

2. The system, via the Internet, verifies a sender by sending him/her a verifying link and a code and the first password crucial for logging into the system.

3. While logging in for the first time, the system forces on you a change of password and carried out a test, quiz and a survey. The test checks the initial/output cognitive and memory user's ability by presenting specific exercises. In a survey participant is asked about his/her interests, the way of spending leisure time, social status, professional status, motivation, the level of advancement and the need for memory training, availability (that includes the date marking the beginning of performing exercises as well as determining the level of difficulty and complexity which would be suitable for the user). A quiz, on the other hand, examines a general level of knowledge and areas of his/her interests.

4. By doing so, the system gathered first information, transferred it to a data base in which a concluding system is located. On the basis of collected information, a new set and schedule of exercises was assigned as well as activities related to memory training

5. A mobile device sends a proper signal (sound or vibration) to a user and that give him/her information about an urge to perform a particular task.

6. Jan Kowalski, who registered in on Sunday evening and determined the level of his advancement as a “beginner” and decided to start practicing from the next Monday—from early morning hours, he receives notifications from the system with a set of consecutive microexercising. AN estimated time to perform those exercises varies from 3 to 5 minutes.

7. Exercises are derived from four groups and types—each of them is responsible for the development of different kinds of memory and other cognitive skills.

8. On the first day Jan Kowalski's a “good morning” exercises is: “Memorize the sequence of only 10 images.”

9. The result he gets is automatically transferred to a data base and on the basis of which the system calculates a specific break in having access to perform the next exercise and also the system will “create” the next task. Assuming that Jan Kowalski has performed the first exercise flawlessly, then the system will propose another exercise at the same level of difficulty. The next exercise, however, will come from another group and will be responsible for the development of a different type of memory. The gradation of difficulties and a specific dosage of training is the key to success—a sustained improvement in cognitive and memory functions.

10. After some time, the device will again inform Janek about another short exercise. Bu this time, it will be a short series of computational exercises—a simple math involving adding a few ingredients. And this time as well, Jan will perform them correctly.

11. Next information about Janek's progress will be transmitted to the data base. Important information: the system, while proposing further exercises and scheduling of tasks, apart from initial information received from John as well as his current results, takes into account other variables such as: a time of day, a decision strongly affecting cognitive processes, an overall Janek's condition resulting, at the same time, from questions which are being sent to him Between exercises and throughout a whole time, the system is in touch with Janek asking him simple questions, which are working on his profile all the time and care creating next tasks. Today Janek was asked i.e. about the length of sleep, general well-being, humor, any trouble, scheduled important issues, the stress level, timing of meals and the quality of meals, exercise. All these elements strongly affect the level of memorizing and cognition, and at the same time keep updating Janke's profile, for which consecutive portions of specially profiled exercises will be prepared.

12. At the end of the day Janek performed four short exercises, each of them originating from a different group, and thus responsible for the development of other capabilities and features.

13. On the first day, however, creating a line of communication between Janek and the system on an everyday basis as well as introducing Janek to a certain rhythm was significant. Janek made a new “friend” who is very interested in him, to whom John “confides in”. This friend gets to know and understands Janek better, and also prepares something for him—of course, while bearing in mind all Janek's preferences and capabilities. We are dealing here with a reversed situation to once famous “animals” Tamagucci, which were fiercely “looked after” by millions of people with better or worse results. In this case, we have a well-known mobile device, such because of its other functions, we rather don't leave, but instead keep frequently at ourselves, even at the bedside, and we don't allow them to “go far” because otherwise we lose contact with the world. The paradox lies in the fact that on one hand we make sure that our device is “not dead”, but on the other hand, because of the use of the system, this very device begins to look after us—at least in terms of memory training Except for the fact that this mobile device provides us with accurate exercises (such which do not overwork us), it also makes us laugh, helps us to develop, and even has a conversation with us from time to time asking subtly about our dream, well-being, or a quality of meals. In that case, we have a faithful and caring friend. All it took was to register into the system.

14. At the end of the day, it tells Janek his results, sums up his achievements, compares them with the results of other users, propose “knowledge pills”, meaning contents and articles that are worth reading, at least in Janek's case. {It will also get information about how much sleep Janek needs and at what hour he would like to get up. It's all needed just to welcome him at an early morning with already prepared exercises and to be able to accompany him all the time, have a conversation, learn about Janek's habits, spot his strong and weak sides, and prepare for him more and more difficult and sophisticated exercises.

15. Since this morning, the system and the cycle begins again, but Janek always has the right to modify his settings by decreasing intensity of an exercise, but this will involve prolonged workout.

The system has been designed for very active people, with little free time, however, for those who care about their development, as well as are attached to their electronic gadgets without which it is difficult to find a place in today's world. In their rhythm a presented system fits in while using well known devices that are hard to handle without, and used to work, to entertain, have fun, and learn. The system learns with them, it learns its user's rhythm of the day, habits, examine his/her abilities and skills and picks sets of exercises for them so as to keep them always attractive. Of course, after each series of exercises Janek is asked to assess the quality of the exercise, its attractiveness and a level of difficulty. The more relevant information the system receives from Janek, the more a more precise exercises it will propose him another time and more accurately work out the schedule.

Thanks to the proposed system and the system which uses mobile devices, a memory training, which is inherently time consuming (typical courses last about a year and require participation two times per week for stationary group meetings. Moreover, such a course requires performing separate exercises as a homework), is presented to people who never would have gone to this form of classes, and feel the need to improve their skills and abilities. Due to the system, without changing their habits and sacrificing a foregoing lifestyle, using a device, which they always take with them anyway, introducing a memory training becomes a pleasure, a nice addition. Some of us will discover that this very device is probably their “soul mate” and will gladly share their insights, habits, comments. Through a fairly easy procedure to register and log into the system, Janek received a personal trainer memory. It won't change your lifestyle or the order of your whole day. It will also not reduce the amount of duties, but will be continually training and coaching your memory. This system adjusts to you not other way round.

In conventional education systems, every person who wants to train something, to learn something, must devote their time, money, reorganize a day, week, organise replacements. Bears quite large costs associated with the introduction of a new activity. In the case of this system, Janek doesn't resign from anything, he doesn't reorganize his day either. He only, in his spare time, performs tasks assigned to him by the “personal trainer”. This trainer gets to know Janek from day to day. Thank to that, he is able to more and more precisely select sets of exercises. He does it until Janek draws a conclusion that his abilities and memorization skills have improved significantly, so that they no longer need training But we must remember that “when an organ not used, it disappears”—so it is with memory training—and any other training Maybe skills will not be completely forgotten, but definitely will retard a bit. Then nothing precludes us to return to the system, refresh your profile, enter the new variables and then make friends with a coach.

Universality of the system as well as of an equipment related to the system, is all about being accessible always and everywhere. Apart from people who have active lifestyle and very little time, the presented system is a perfect solution not only for them, but also for students who struggle with lack of time—but at the same time are very accustomed to different types of devices and are open towards state-of-the-art systems. Students are also the most important group of users in terms of the development of memory and all cognitive abilities. Elements of social networking sites proposed by the system, ability to work in a group, rivalry and comparing each others results, modules with interesting games and the whole interaction with “personal trainer”, are advantages that can impress the younger part of potential users.

Regardless of the targeted audience, the most important feature of the system is the fact that the central role is played here by a man. It is he who gives the date all its' meaning and on the basis of conducted analysis of these data, he makes decisions. Innovation of this solution is primarily a system concluding on the basis of the data enriched with a description of the semantics.

The main distinguishing feature of this system is knowledge of the semantics of the data described formally by means of meta data and concluding, while assuming incompleteness of information. In this way it will create an innovative international system which doesn't only support the process of data processing, but also imitates and automates the processes of concluding. A concluding system supports all processes related to automatic selection of the appropriate scenario and course of exercises depending on capabilities and progress of a particular user.

The basic components of the concluding subsystem is: 1} Entrance music (calm music is playing as people are entering) accesses interface subsystem 2 Concluding system a. layer of rules—which is a mathematical representation of the rules under which the applicant proceed b. layer semantics of the data—the terminology, the description of the terms of the modeled reality, relations between them, data about data Third data management system—a layer of the data expressed in the form of structural or half structural (relational data, XML, CSV data)

Basic advantages of the system: supporting collaboration processes within a group, modules devoted to supporting automation of a proper selection, presentation, processing and evaluation of a participant of this exercise. The system picks every element individually from its large base gathered for its purposes (initially inscribed data, the system which learns and profiling participants on the basis on their preferences towards layout, graphics, frequency of visits various aspects of the aid given answers to each question tests, polls, quizzes, etc.). A personalized graphical interface, intuitive and easy to use, which is consistent with applicable standards of graphical interface creation for users of mobile devices. Support for the disabled. The system is basically open on the whole Europe and the world thanks to introducing multilingualism and possibility of a simple translation extension, from the beginning performs all functionality regardless of where an extensive system administrator permissions to allow accurate determine the possibility of individuals using the system; extensive possibilities for allocating, sharing, reporting and supervision of the execution of tasks; sharing and supervision of e-calendar; expanded automation capabilities combined with the features of a dedicated flow of information and tasks, and any configuration of scale automation control functions.

What is claimed is:

1. The system uses mobile devices for stimulating the brain, characterized with having three logic types of components/sections: information section, wherein the system information part consists of a functional components in the form of administrative panel containing information management, knowledge panel that enables looking through the system's published content and its presentation, newsletter. This newsletter is responsible for handling the subscription process, advertising module, the department of exercise, realizing automatic and interactive exercises, training and lessons divided into 4 subgroups: mnemonic exercises, logical, computational, visual, and independent internal learning module, a database—data collection department and the effects of exercise, containing components: a knowledge base module, the module pseudo concluding based on user profiles, and manages user accounts and statistics department and assessments.

2. The method and system which uses mobile devices to stimulate the brain work, is characterized with the fact that a user, with a mobile device with access to the Internet, logs into the system through a created for this purpose database's component authentication, authorization, supporting users' accounts. He enters identification information and complete the quiz. Then, on the basis of these data the user, he/she is provided with appropriate for the functional scope, Then, he/she gives some initial identification information and does a short quiz. On the basis of already completed tasks, we make an appropriate functional scope available for a user. Then, a user creates a user account and password assigned. Sequentially the system determines a profiled task, initial tests and quizzes, and sets the timetable for their implementation. The mobile device, correlated with the system, functions as a reminder of specific activities and tasks that were imposed on the user who decided to undergo the process of training memory. The user solves tasks, and information of his/her results are transmitted to a database that is located on an outside server. One the basis of results, in the data base information is processed, the system of statistics is built and the next task is assigned—this task is a consequently connected with previously performed tasks.
